(19) United States
(12) Patent Application Publication
(10) Pub. No.: US 2015/0293672 A1
(43) Pub. Date: Oct. 15, 2015

(54) Guided edits for images and/or video

(71) Applicants: Teresa Crotty, San Jose, CA (US); Mark Dahm, Gilroy, CA (US); T. Todd Donahue, Encinitas, CA (US); David Rau, Carlsbad, CA (US); Delmer R. Schneider, JR., Manteca, CA (US)

(72) Inventors: Teresa Crotty, San Jose, CA (US); Mark Dahm, Gilroy, CA (US); T. Todd Donahue, Encinitas, CA (US); David Rau, Carlsbad, CA (US); Delmer R. Schneider, JR., Manteca, CA (US)

(73) Assignee: Adobe Systems Incorporated

(21) Appl. No.: 11/903,466

(22) Filed: Sep. 21, 2007

(51) Int. Cl. G06F 3/0484; G06F 3/01; G06F 17/00; G06F 17/30

(52) U.S. Cl. CPC G06F 3/04845; G06F 3/04842

(57) ABSTRACT

A selection of visual data on which an edit is to be performed is received. Information associated with the edit to be performed is obtained, including a description and a control. A parameter associated with the visual data is obtained, and the visual data, the description, and the control are simultaneously displayed, where some part of the display is based at least in part on the parameter. Via the control, an indication to perform the edit is received. The edit is performed on the visual data and the visual data with the edit performed is displayed.

### BACKGROUND OF THE INVENTION

Interfaces for editing or manipulating images or video (e.g., associated with a desktop based application or a web based application) offer a variety of tools and controls. For example, a user can create and work with layers, add tags, adjust color related properties, cut and paste portions of the video or image, etc. To assist users in editing or otherwise manipulating an image or video, some interfaces have tools or features that demonstrate how to perform a particular edit or change on a video or image. For example, previous versions of Adobe® Photoshop® Elements (i.e., versions 1.0 thru 5.0) offered a feature called recipes. It would be desirable if such a help related feature could be further improved, for example by improving the visibility for a user when such a feature is used.

### BRIEF DESCRIPTION OF THE DRAWINGS

Various embodiments of the invention are disclosed in the following detailed description and the accompanying drawings.

FIG. 1 is a diagram illustrating an embodiment of an interface associated with guided edits.

FIG. 2 is a flowchart illustrating an embodiment of a process for detecting and displaying a list of guided edits to a user.

FIG. 3 is a diagram illustrating an embodiment of a guided edit for cropping.

FIG. 4 is a diagram illustrating an example of the recipes features.

FIG. 5A is a flowchart illustrating an embodiment of a first part of a process for editing a video or image using a guided edit.

FIG. 5B is a flowchart illustrating an embodiment of a second part of a process for editing a video or image using a guided edit.

FIG. 6 is a block diagram illustrating an embodiment of a guided edit and an image or video editing application.

FIG. 7 is a diagram illustrating an embodiment of a guided edit associated with rotating and/or straightening.

FIG. 8 is a diagram illustrating an embodiment of a guided edit for sharpening.

FIG. 9 is a diagram illustrating an embodiment of a guided edit associated with lightening or darkening.

FIG. 10 is a diagram illustrating an embodiment of a brightness and contrast guided edit.

FIG. 11 is diagram illustrating an embodiment of a guided edit associated with enhancing color.

FIG. 12 is a diagram illustrating an embodiment of a guided edit associated with color cast.

FIG. 13 is a diagram illustrating an embodiment of a skin tone correction guided edit.

FIG. 14 is a diagram illustrating an embodiment of a guided edit for touching up an image.

FIG. 15A shows an embodiment of a first atomic guided edit for cropping.

FIG. 15B shows an embodiment of a second atomic guided edit associated with the lightening or darkening.

FIG. 15C shows an embodiment of a third atomic guided edit associated with touching up.

FIG. 15D is a diagram showing an embodiment of a fourth atomic guided edit for sharpening a photo.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

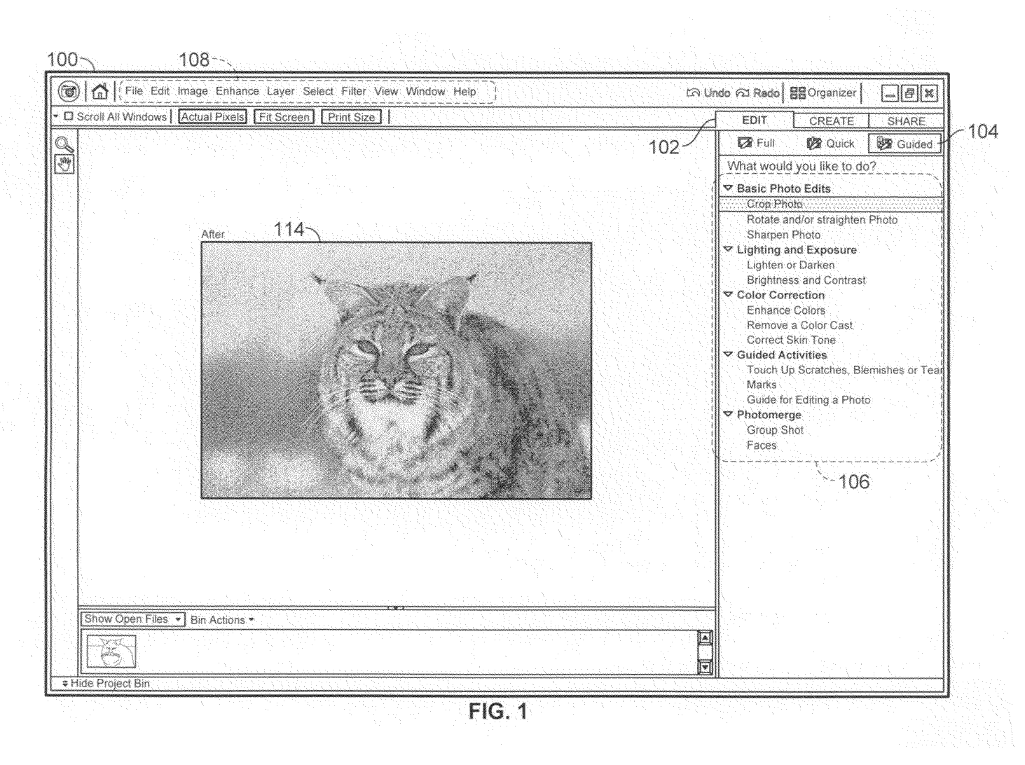

FIG. 1 is a diagram illustrating an embodiment of an interface associated with guided edits. In the example shown, interface 100 is associated with Adobe Photoshop® Elements®, an application for editing digital images (e.g., Joint Photographic Experts Group (JPEG), Graphics Interchange Format (GIF), Microsoft Windows Bitmap (BMP), etc.) and/or video (e.g., Moving Pictures Expert Group (MPEG), Windows Media format (WMV), etc.). In some embodiments, the techniques described herein are used by some other application besides Adobe Photoshop Elements. In various embodiments, the techniques described herein are used by a web interface (e.g., accessed via an Internet browser application such as Microsoft Explorer or Mozilla Firefox) or an interface associated with a desktop application installed on and running on a device.

In this example, one way a user is able to view guided edits list 106 is by selecting edit tab 102. For clarity, a dashed box with rounded edges is shown around guided edits list 106; in some embodiments the dashed box is not actually shown to a user. In some embodiments, a user selects edit tab 102 by placing a mouse cursor over edit tab 102 and clicking on edit tab 102. Once edit tab 102 is selected, the user is presented with the buttons full, quick, and guided. By selecting guided button 104, guided edits list 106 is presented to the user. In some embodiments some other interaction with interface 100 causes guided edits list 106 to be presented.

Guided edits list 106 in this example has 12 guided edits organized into different categories. The first category (i.e., basic photo edits) includes crop photo, rotate and/or straighten photo, and sharpen photo. The other categories in this example are lighting and exposure (which includes the guided edits lighten or darken, as well as brightness and contrast), color correction (which includes enhance colors, remove a color cast, and correct skin tone), guided activities (which includes touch up scratches, blemishes or tear marks, as well as guide for editing a photo), and photomerge (which includes group shot and faces). Embodiments of the guided edits shown in guided edits list 106 are shown in further detail below.

Image 114 is the selected image on which a guided edit is performed. In some embodiments, a guided edit is able to be performed on a video. In this particular example, image 114 is selected before a user has selected a guided edit to perform on image 114. Alternatively, a user in some embodiments is able to select a guided edit to apply and then locates and/or selects a video and/or image to apply the guided edit to. In various embodiments, an image or video upon which a guided edit is performed has had no or some edits (e.g., guided edits) already applied. In some cases for example, image 114 is a “raw” or original image that has not been processed. In other cases, image 114 may have had one or more edits performed on it. For example, a user may have sharpened image 114 using the sharpen guided edit in guided edit list 106, or via pull down menus 108.

A guided edit permits a (novice) user to perform a task or change associated with visual data (e.g., a video, an image, etc.) without necessarily having to know a preferred or proper sequence of steps. The task or change associated may be to delete or remove information, add or create information, and/or change or modify information. For example, some users may not know that it is good practice to crop an image first and then adjust color. Or, some users may not know where a particular tool brush, slider, dialog box, checkbox, radio button, or other control is accessed via pull down menus 108. Some guided edits permit a user to perform a particular task or edit without having to use pull down menus 108 at all. This can be attractive for applications for which pull down menus are very complex or extensive. (Pull down menus 108 are shown in this figure with a dashed box for clarity; this dashed box is not necessarily shown to a user.) In some cases, guided edits make an application or interface more accessible or user friendly and offers a competitive advantage over other interfaces or applications that do not use guided edits.

In some embodiments, a guided edit is associated with metadata. For example, a guided edit may be associated with adding, modifying, or deleting a tag associated with a video or image. In some embodiments, a video or image includes a plurality of layers and a layer (or an object in a layer) is added, modified or deleted. In some embodiments, a guided edit affects or is associated with one or more images or videos. For example, a guided edit may be to concatenate two videos together. In another example, guided edit list 106 includes guided edits associated with merging (i.e., group shot and faces in the photomerge category).

In some embodiments, the format of, the interface for, and/or any other information needed for a third party, user, or other entity to build their own guided edit is made accessible or exposed. In some embodiments, a third party is an entity that is neither the user nor is associated with a company which developed an image or video editing application that a guided edit interacts with. In some embodiments, this information is made publicly accessible for anonymous access so that a third party can create their own guided edit without the owner of the application or interface being aware of the created guided edit, the entity that created it, etc. In some cases, this offers an advantage over some previously existing features, such as a feature called recipes which is available in some previous versions of Adobe Photoshop® Elements®. Recipes were proprietary to Adobe and third parties could not create and/or distribute their own recipes. In embodiments where the format of or other information associated with guided edits is made available, third parties are able to create and/or distribute their own guided edits. The following figure illustrates one embodiment for detecting and presenting guided edits.

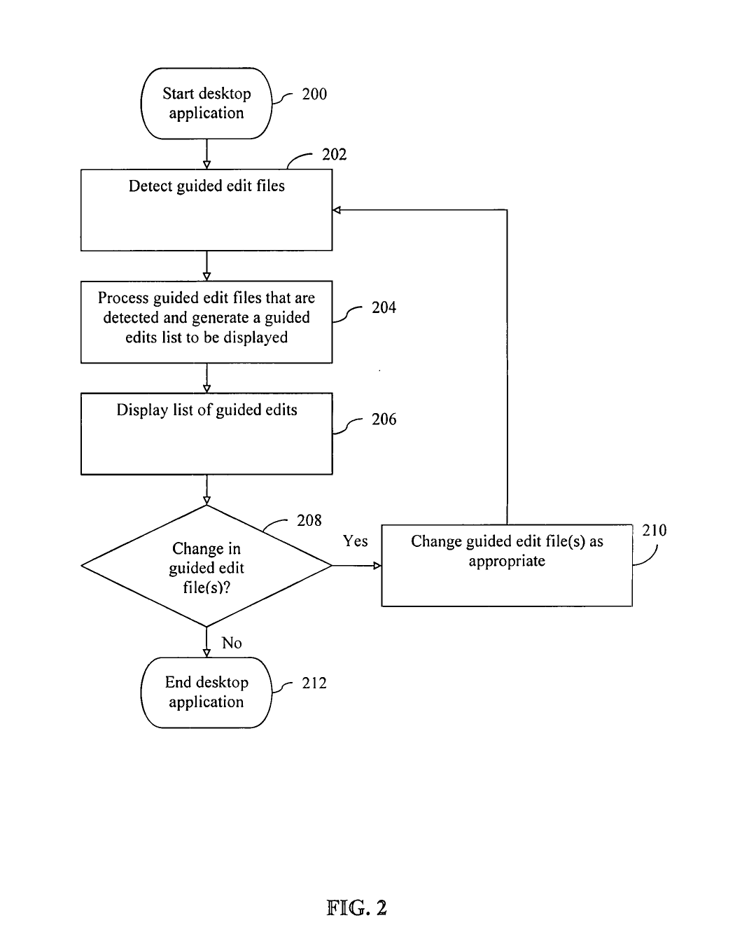

FIG. 2 is a flowchart illustrating an embodiment of a process for detecting and displaying a list of guided edits to a user. In some embodiments, the example process is used to present guided edits list 106 in FIG. 1. In this example, guided edits are associated with a desktop application that is installed on a local computer or device and run on that local device. In some embodiments, there is some number of guided edits that are released with the desktop application. In some embodiments, a new or updated guided edit is released for free to users who purchase and/or register their copy of the desktop application. In some embodiments, a guided edit is created and made available by a third party. In some embodiments, a guided edit is made available on a subscription or fee basis (e.g., from Adobe or a third party).

At 200, a desktop application is started. In some other embodiments, guided edits are associated with a web interface as opposed to a desktop application and the example process is modified as needed. At 202, guided edit files are detected. In this embodiment, each guided edit is associated with its own guided edit file. (Alternatively, guided edits can be stored or managed in some other manner.) In some embodiments, guided edit files are stored in a particular location (e.g., a particular folder in a computer's file system or on a server over the Internet) and that location is accessed to determine what files or other data is contained there.

Guided edit files that are detected are processed and a guided edits list to be displayed is generated at 204. In some embodiments, a file detected at 202 contains a field for the name of that guided edit or in some other manner specifies the name to be used in a guided edits list generated at 204.

At 206, a list of guided edits is displayed. In various embodiments, a display at 206 is triggered or initiated by a variety of user inputs or selections. Referring back to FIG. 1, display at 206 in that example is caused (at least in some cases) by a user selecting edit tab 102 and guided button 104.

It is determined at 208 whether there is a change in the guided edit file(s). In some embodiments, a guided edit file replaces an existing guided edit. For example, based on user feedback, a creative entity may change a particular guided edit (e.g., with clearer instructions) and create a new guided edit file to replace an existing guided edit. In some embodiments, a new guided edit is created and distributed. For example, an entity may provide a guided edit that shows a user how to improve photographs taken at night where the people in the foreground are washed out by the camera's flash but the background is dark and difficult to make out. In some embodiments, a guided edit is removed.

If there is a change, guided edit file(s) are changed as appropriate. For example, in the case of replacing an existing guided edit file, in some embodiments the new guided edit file is obtained and stored in a proper or designated location and the obsolete file is deleted. Steps 202-208 are then repeated. In some embodiments, display of an updated guided edits list at 206 is performed at some appropriate time (e.g., the next time a user selects edit tab 102 and guided button 104).

Returning back to the example of FIG. 1, the crop photo guided edit from guided edits list 106 is described in further detail below. The following figures are merely examples and are not intended to be limiting. A guided edit can be associated with any modification or edit to a video or image (e.g., in addition to or as an alternative to the examples shown herein).

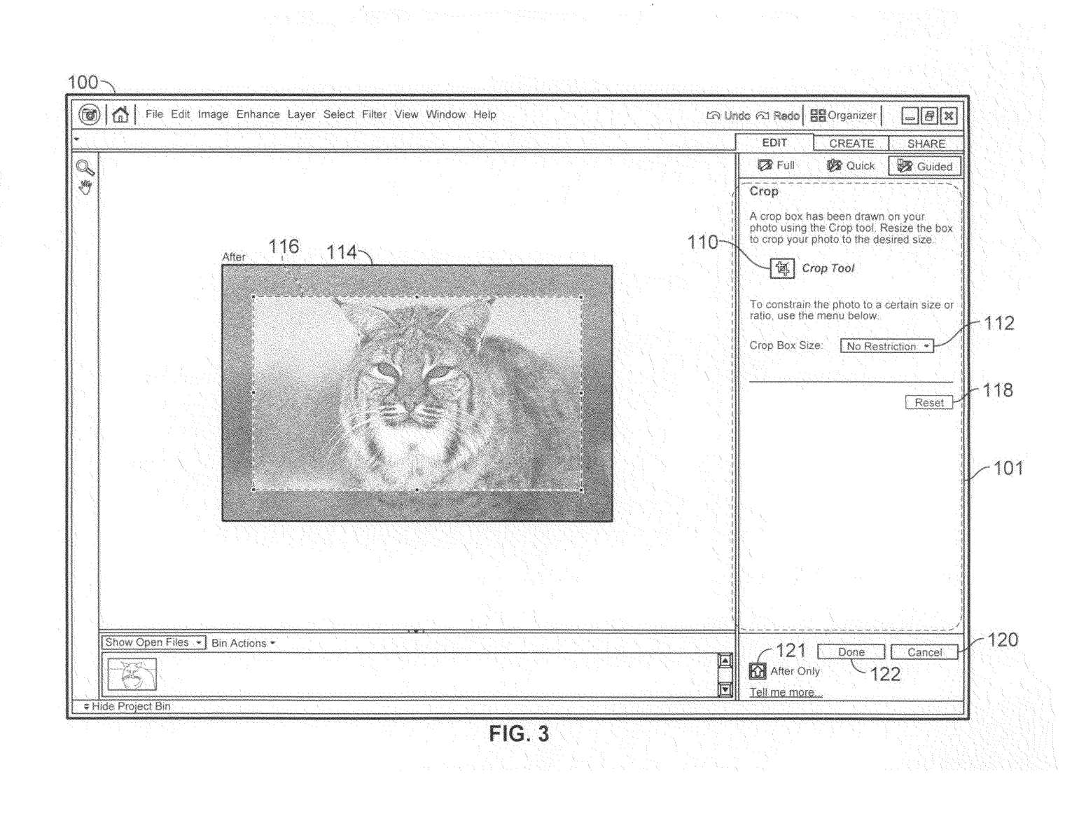

FIG. 3 is a diagram illustrating an embodiment of a guided edit for cropping. In the example shown, a user views interface 100 in the state shown in FIG. 1 and selects the crop photo guided edit from guided edits list 106 by clicking on the text “crop photo” using a mouse. This causes interface 100 to change to the state shown in FIG. 3. In some embodiments, some other selection action (in addition to or as an alternative to clicking) causes a particular guided edit to be displayed.

Description and controls associated with the crop photo guided edit are presented in a column along the right edge of interface 100. In some embodiments, a description associated with a guided edit is static (i.e., it is neither interactive nor selectable). For example, double clicking on the text “A crop box has been drawn on your photo . . . ” will not cause anything to be selected or changed. In this figure, the controls include crop button 110 and crop box size pull down menu 112. In various embodiments, a control is a tool (e.g., an eyedropper tool, an eraser tool, a brush tool, etc.), a button, a slider, a box for entering numerical values or strings, a radio button, a checkbox, or any other user interface control. In some embodiments, checkboxes and radio buttons have different rules (e.g., multiple checkboxes can be selected at the same time but radio buttons are mutually exclusive and only one radio button can be selected at a given time). The instructions/description and controls to present are specified in a corresponding guided edits file.

In this example, when a crop photo guided edit is selected, the crop tool is selected and an initial crop (indicated by crop box 116) is automatically indicated and/or performed on image 114 without a user having to do anything. From this default or initial crop, a user can (if so desired) use crop box size pull down menu 112 to constrain image 114 to a certain size or aspect ratio and/or adjust crop box 116.

In this example, guided edits are configured to exchange data (e.g., instructions, values, parameters, etc.) bi-directionally between an underlying application (e.g., Adobe Photoshop Elements) and a guided edit (e.g., to/from a particular control). For example, in the guided edit to application direction, a user can specify a particular aspect ratio or size using control crop box size pull down menu 112. This causes an instruction and associated values or parameters to be sent to the underlying application (in this case Adobe Photoshop Elements) specifying that the specified aspect ratio or size be applied to image 114. As an example of data exchange in the other direction, suppose a selected image (e.g., image 114) has already been cropped, e.g., using a cropping tool accessed via pull down menus 108. In some embodiments, a last or saved cropping is sent from an underlying application to the guided edit and corresponding control(s) are set accordingly to reflect that cropping (e.g., crop box size pull down menu 112 takes on the obtained value and/or crop box 116 is set to the obtained size and position). In such embodiments, when the crop photo guided edit is first selected, the previous or saved cropping is reflected by crop box 116 and crop box size pull down menu 112.

In this example, if a user does not like the changes made using the guided edit, he can press reset button 118 (e.g., using a mouse or other input device), causing crop box 116 to reset, for example to an original image or video with changes that were performed prior to opening a guided edit. In this example, pressing cancel button 120 causes all cropping changes made using the guided to be canceled. After pressing cancel button 120 in this example, a guided edits list (e.g., the state shown in FIG. 1) is displayed and the cropping guided edit is no longer displayed. After only button 121 (which in this example is selected) is used to control what image(s) is/are displayed. In the after only state, an after image with all changes applied is displayed, including those changes or edits made using the guided edit. Otherwise, both a before image (e.g., the original image and any changes that were applied prior to opening of the cropping guided edit) and an after image are displayed.

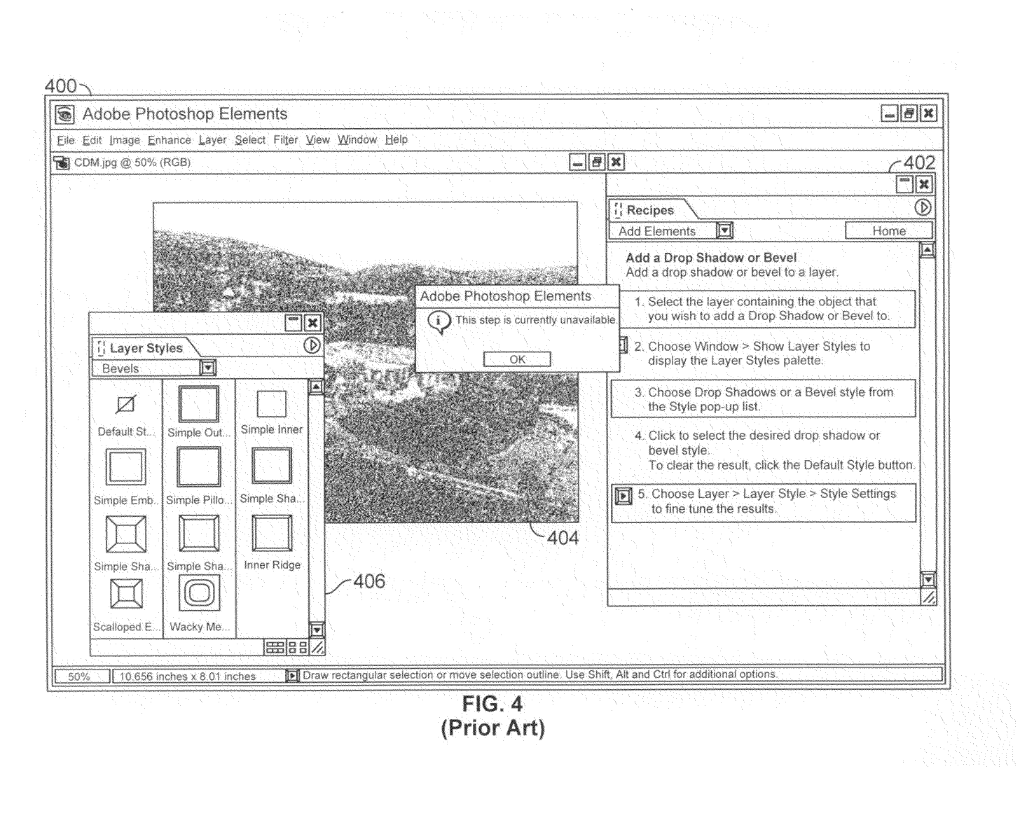

FIG. 4 is a diagram illustrating an example of the recipes features. In the example shown, interface 400 is associated with a previous version of Adobe Photoshop Elements (e.g., versions 1.0 thru 5.0). In this example, interface 400 includes recipes window 402. Recipes window 402 floats within interface 400 and the position and size of recipes window 402 can be adjusted as desired by a user. For example, the user can (if so desired) move recipes window 402 from its current position on the right side of interface 400 to the left side.

Layer styles palette 406 is also displayed within interface 400. For example, a user may have performed or activated step 2 of the recipe, causing layer styles palette 406 to be displayed. A user is able to control the position and size of layer styles palette 406 as desired.

One advantage that at least some embodiments of a guided edit offers over this example of recipes is improved visibility. Note that in this figure, layer styles palette 406 blocks the lower left corner of the image shown in CDM.jpg window 404. Although a user is able to adjust the size and/or position layer styles palette 406 so that it does not block CDM.jpg window 404, this requires extra work on the part of the user. In interface 100, all of the controls (in that embodiment for cropping) are already exposed without requiring a palette, dialog box, or other window to pop up.

In some cases, a palette, dialog box, or other window that pops up when using recipes is annoying because the presented window is modal. A modal window is one that does not allow focus to be shifted to another window associated with that application (e.g., using a mouse pointer and clicking on a desired window) until the modal window is closed. For example, since layer styles palette 406 is modal, a user is not be able to focus on other windows (e.g., recipes window 402 or CDM.jpg window 404) until layer styles palette 406 is closed. This can be annoying if the user wants to select another window, for example to zoom in on part of the image in CDM.jpg window 404 or to scroll down recipes window 402 if a step is long is and is cut off by the bottom edge of the window.

Another advantage that guided edits offers is bi-directional data exchange. In recipes, data is sent from the recipe to Adobe Photoshop Elements, but not in the other direction. As a result of this, recipes window 402 cannot display some information that a guided edit (e.g., located in the right hand column of interface 100) is able to display. For example, suppose the image had already been fine tuned (corresponding to step 5 in recipes window 402) and then recipes window 402 is opened. Recipes window 402 cannot obtain the style settings set prior to opening recipes window 402 and thus cannot display the values in recipes window 402. It may be necessary to open a style settings window for a viewer to see what style settings were selected.

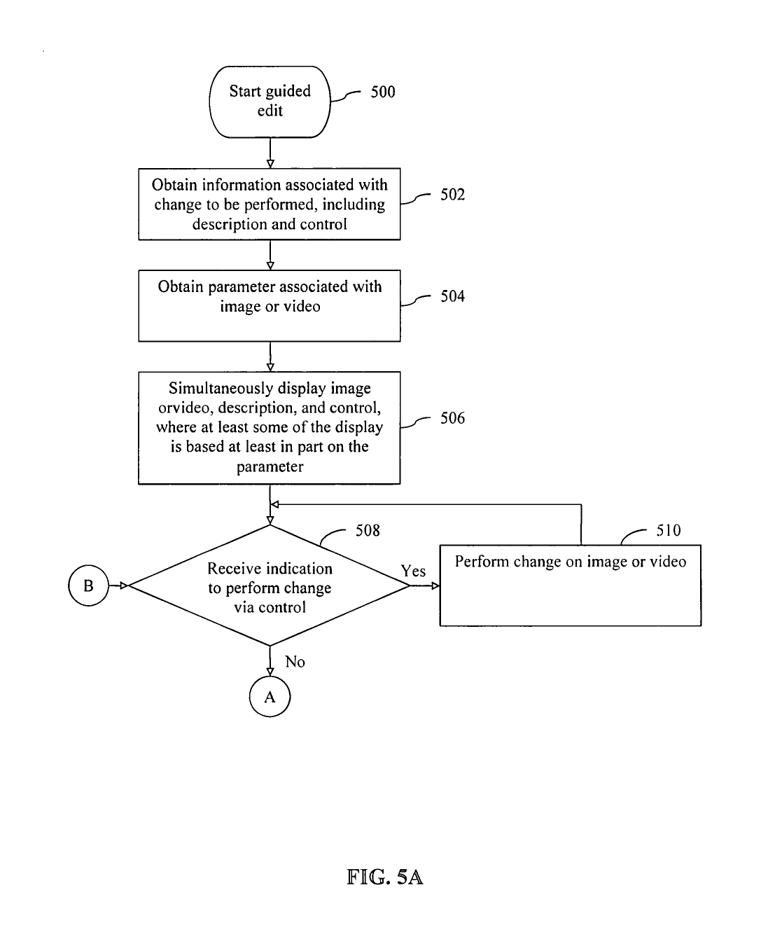

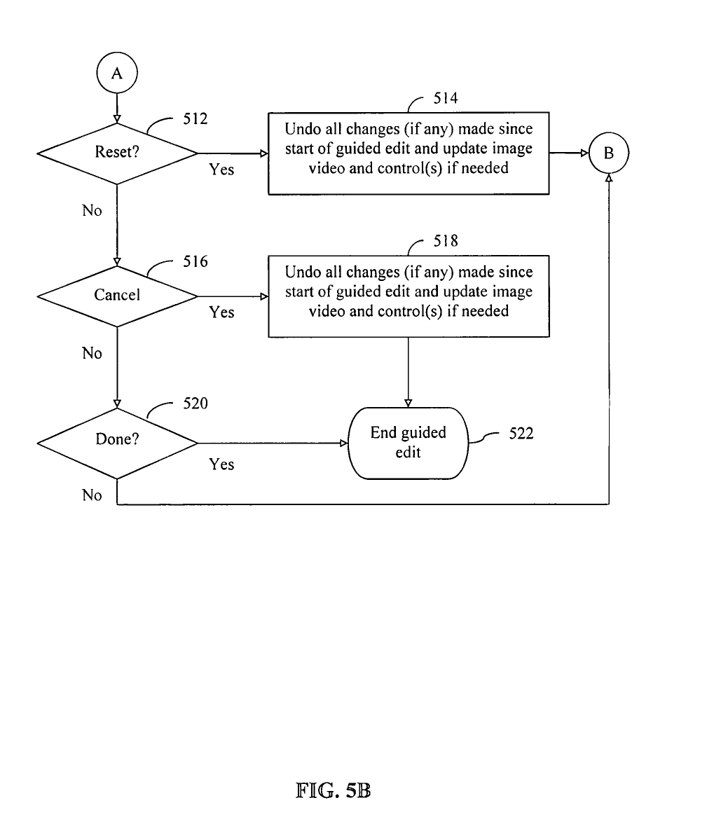

FIGS. 5A and 5B are flowcharts illustrating an embodiment of a process for editing a video or image using a guided edit. At 500, a guided edit is started. In some embodiments, a guided edit is started when a user selects a guided edit from a list (see, e.g., FIG. 2). Information associated with a change to be performed is obtained, including a description and a control at 502. In some embodiments, each guided edit is associated with a file that includes the description and control. In some embodiments, an identification of a control is obtained at step 502. For example, in FIG. 3, an identifier associated with crop tool button 110 is obtained at 502.

At 504, a parameter associated with an image or video is obtained. For example, if the size and/or aspect ratio of image 114 in the example of FIG. 3 has already been constrained, in some embodiments the particular aspect ratio and/or size already applied is obtained. In various embodiments, a parameter is some other value, setting, or mode associated with a selected image or video, such as a value associated with brightness, hue, or saturation; an alphanumeric value of a tag; layer related information; etc. At 506, the image or video, description, and control are simultaneously displayed, where at least some of the display is based at least in part on the parameter. To continue the above example, the setting or state of crop box size pull down menu 112 in FIG. 3 in such embodiments would reflect the size and/or aspect ratio obtained at 504.

At 508, it is determined if an indication to perform a change is received via a control. In FIG. 3, for example, a user may adjust crop box 116 or the selection of crop box size pull down menu 112. In some embodiments, displacing or moving a slider is a sufficient indication to perform the change. In some embodiments, an indication comprises some other action or input. For example, if a control is a box for entering an alphanumeric value, in some embodiment pressing the enter key comprises an indication to perform a change.

If an indication is received, at 510 the change is performed on the video or image. In some embodiments, an instruction to perform the change and any values, parameters, or other information required for that particular change is assembled by a module or agent associated with a guided edit and is transmitted to an underlying application (e.g., Adobe Photoshop Elements) and the application executes or processes the instruction using the provided values or parameters (if needed). The exchange of information is bidirectional and in some embodiments, some value or data is returned to a module or agent associated with the guided edit.

Otherwise if no indication is received, it is determined at 512 whether to reset. In FIG. 3 for example, a reset occurs if reset button 118 is pressed. If so, all changes (if any) made since the start of a guided edit are undone and the image or video and control(s) are updated if needed at 514. As an example of updating a control at step 512, in some embodiments, a control reflects the current value or state and the control is returned to the value it was when the guided edit was started.

If it is determined not to reset, it is determined at 516 whether to cancel. In some embodiments, a cancel occurs if a cancel button (e.g., cancel button 120 in FIG. 3) is pressed. If so, at 518 all changes (if any) made since the start of a guided edit are undone and the image or video and control(s) are updated if needed. In this example, a reset is the same as a cancel, except a cancel closes the guided edit.

If it is determined not to cancel, at 520 it is determined whether a process is done. For example, the user may press done button 122 in FIG. 3. If so, a guided edit ends at 522.

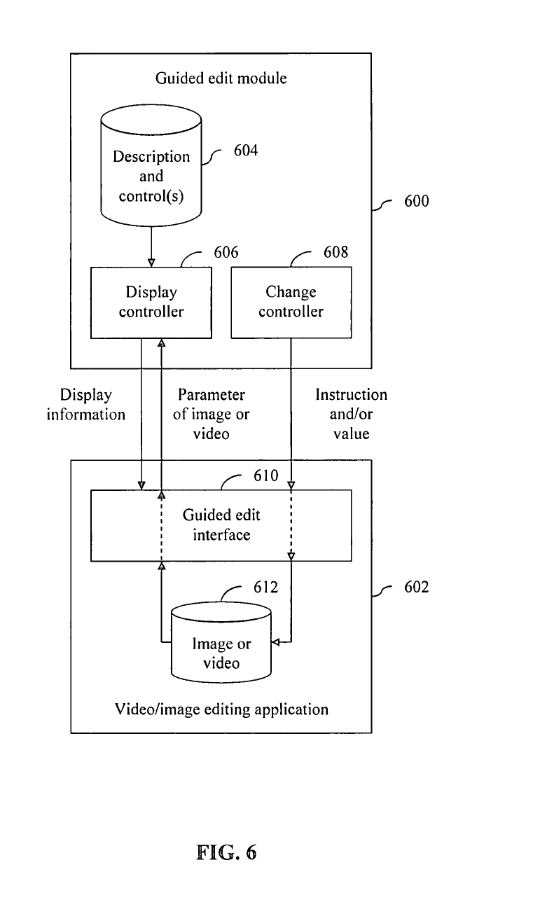

FIG. 6 is a block diagram illustrating an embodiment of a guided edit and an image or video editing application. In the example shown, guided edit 600 and video or image editing application 602 (hereinafter referred to as application 602) are operable and functional independently of each other. That is, application 602 is able to work without guided edit 600 and vice versa. Although this embodiment shows only one guided edit module (i.e., guided edit 600), in some cases there are multiple guided edit modules, each capable of operating independently of any other guided edit module. In some embodiments, for each guided edit there is a corresponding module.

In some embodiments, a guided edit is implemented using Adobe Flash and guided edit module 600 is a SWF file. In some embodiments, guided edit module 600 is implemented using some other technology.

Guided edit module 600 includes description and control(s) 604, display controller 606, and change controller 608. Display controller 606 is responsible for managing a display. In some embodiments, application 602 lets guided edit module 600 control what is displayed for at least a portion of an interface. For example, in FIG. 3 the part of interface 100 where the display is controlled by the guided edit may be portion 101. A parameter associated with image or video 612 is passed from guided edit interface 610 to display controller 606; this parameter affects some part of the display. In one example, the parameter is associated with brightness, hue, or saturation and the value of the parameter affects the position of a slider (e.g., that displays and/or controls brightness, hue, or saturation) in a portion of a display controlled by a guided edit. Display information is passed from display controller 606 to guided edit interface 610.

Change controller 608 is responsible in this example for detecting an indication from a user to perform a change on an image or video. In this example, an instruction and/or value is passed from change controller 608 to guided edit interface. This is then applied to image or video 612. In one example, the instruction is to crop an image and the values may be the size or dimensions of the cropping. In some embodiments, change controller 608 tracks the changes performed since the start of a guided edit. In the event of a reset or cancel, the saved change information is used to undo or restore the image or video to the state it was when the guided edit started.

Returning back to the embodiment shown in FIG. 1, some embodiments of the other guided edits shown in guided edits list 100 are described in further detail below.

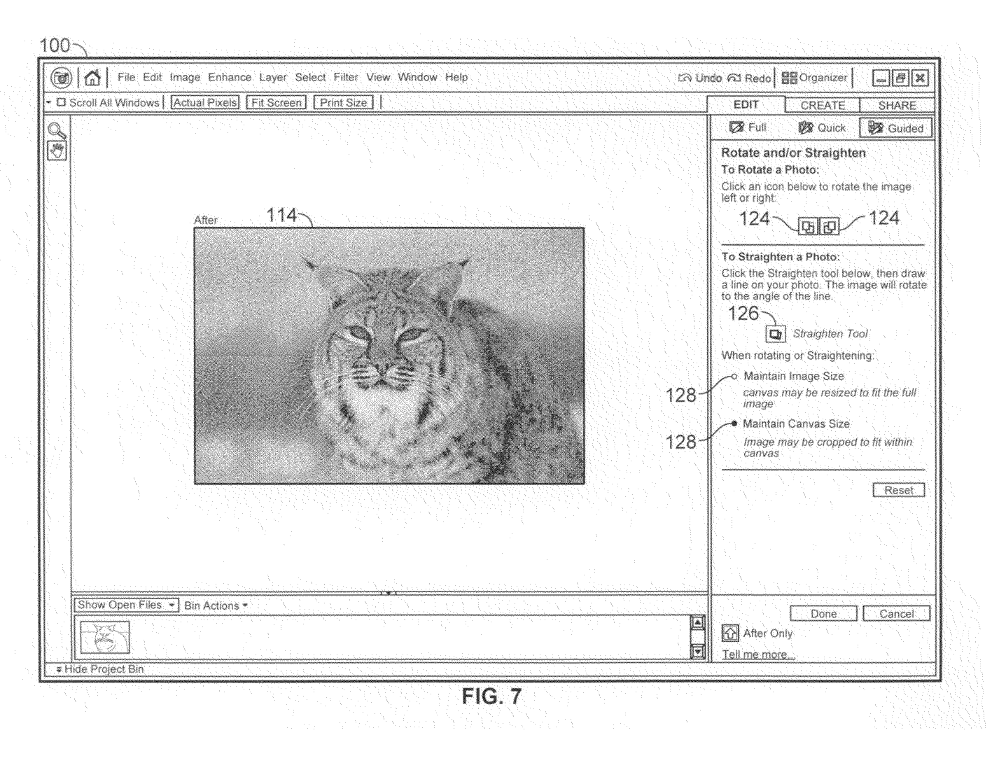

FIG. 7 is a diagram illustrating an embodiment of a guided edit associated with rotating and/or straightening. In the example shown, interface 100 has controls exposed and instructions displayed that relate to rotating or straightening an image or video. To rotate image 114 or some other selected image or video, rotate buttons 124 can be used, causing a rotation to the left (i.e., counterclockwise) or right (i.e., clockwise). To straighten a selected image or video, straighten tool button 126 can be selected. Once selected, the user can draw a line on image 114 and the image will rotate based on the angle of the line. Radio buttons 128 maintains image size or alternatively maintains canvas size when rotating or straightening.

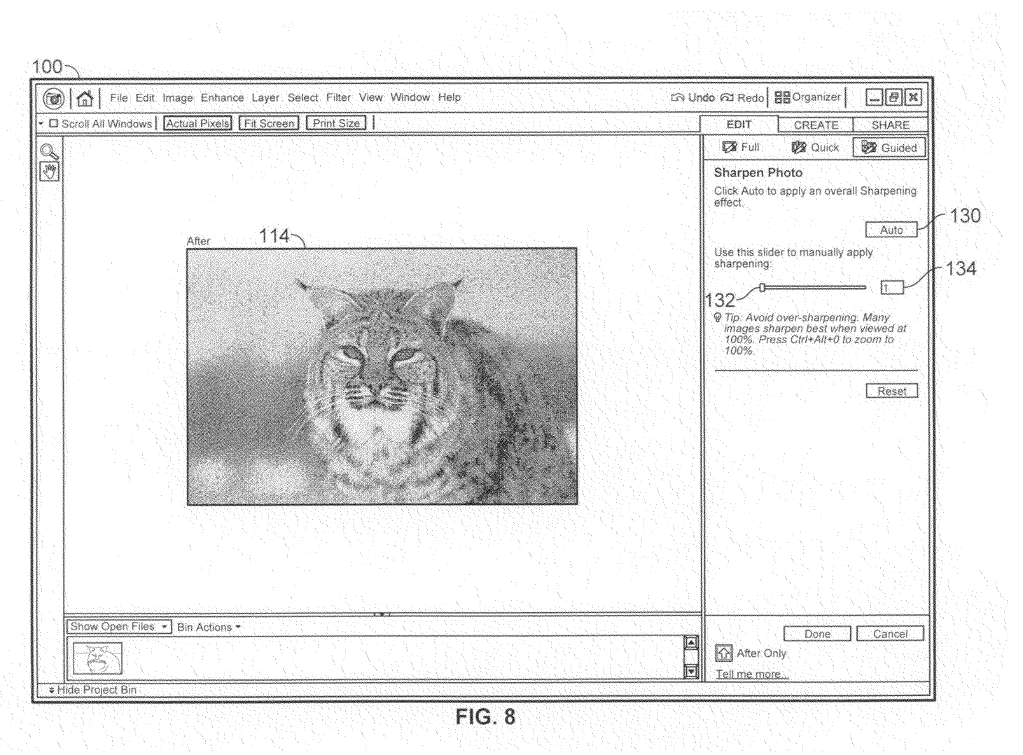

FIG. 8 is a diagram illustrating an embodiment of a guided edit for sharpening. In the example shown, a user has the option of automatically or manually sharpening image 114 (or some other selected video or image). To automatically apply an overall sharpening effect on image 114, a user can press auto button 130. To manually adjust the sharpening effect, a user can adjust slider 132. In some embodiments, a user can use both techniques. For example, in such embodiments the user may first automatically sharpen a selected image or video using auto button 130 and then manually adjust the sharpness using slider 132. In some embodiments, a sharpness value displayed in box 134 reflects both a sharpness value applied automatically (i.e., by pressing auto button 130) as well as manually (i.e., by adjusting slider 132).

In some embodiments, adjusting a control (e.g., slider 132) affects a selected image or video (e.g., image 114) in real time. For example, a user may be moving slider 132 by positioning a mouse pointer over slider 132 and pressing down and holding a mouse button. A user in such embodiments is able to see in real time the effect of moving slider 132 and can decide whether to increase/decrease the sharpness. This may be more convenient than interfaces that require a user to release a slider or other control before a change is applied to a selected image or video. A user would not have to (for example) repeatedly adjust the slider, release the slider, and observe the change. This may provide better control for precise or fine changes to an image.

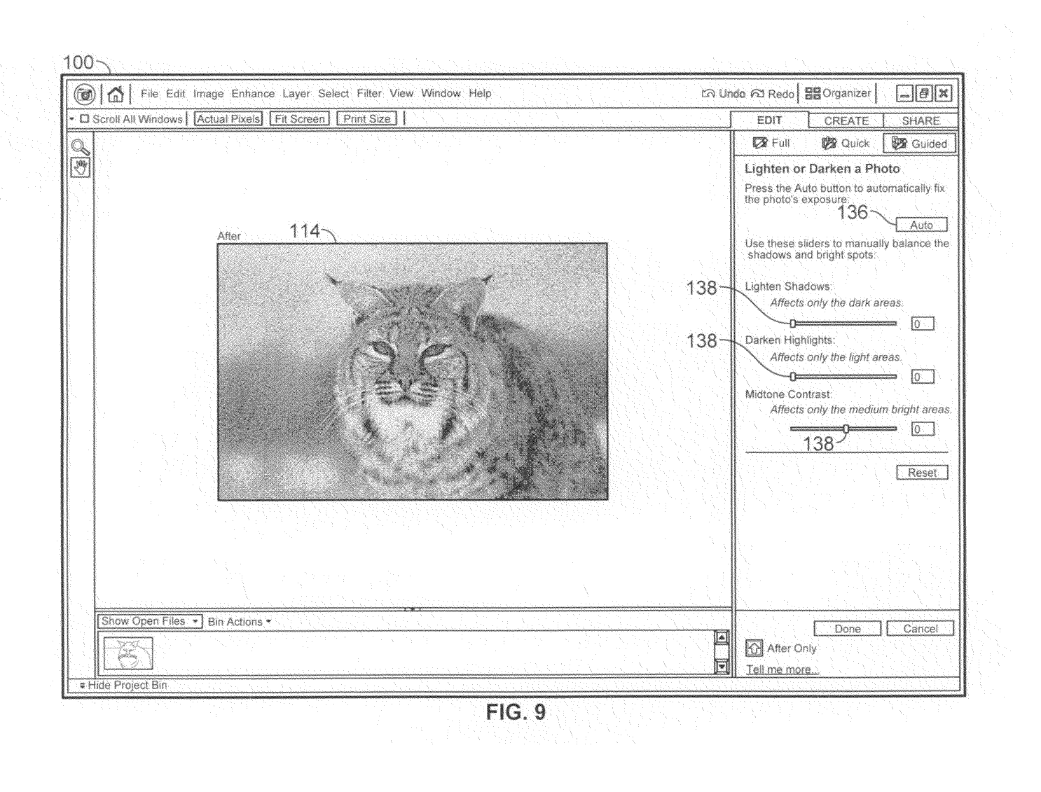

FIG. 9 is a diagram illustrating an embodiment of a guided edit associated with lightening or darkening. In the example shown, image 114 can be lightened or darkened automatically or manually using the example guided edit. To automatically fix the exposure of image 114, a user can press auto button 136. To manually balance the shadows and bright spots, sliders 138 can be used. One lightens shadows (i.e., only affects dark areas), another darkens highlights (i.e., only affects light areas), and a third affects midtone contrast (i.e., affects only the medium-bright areas).

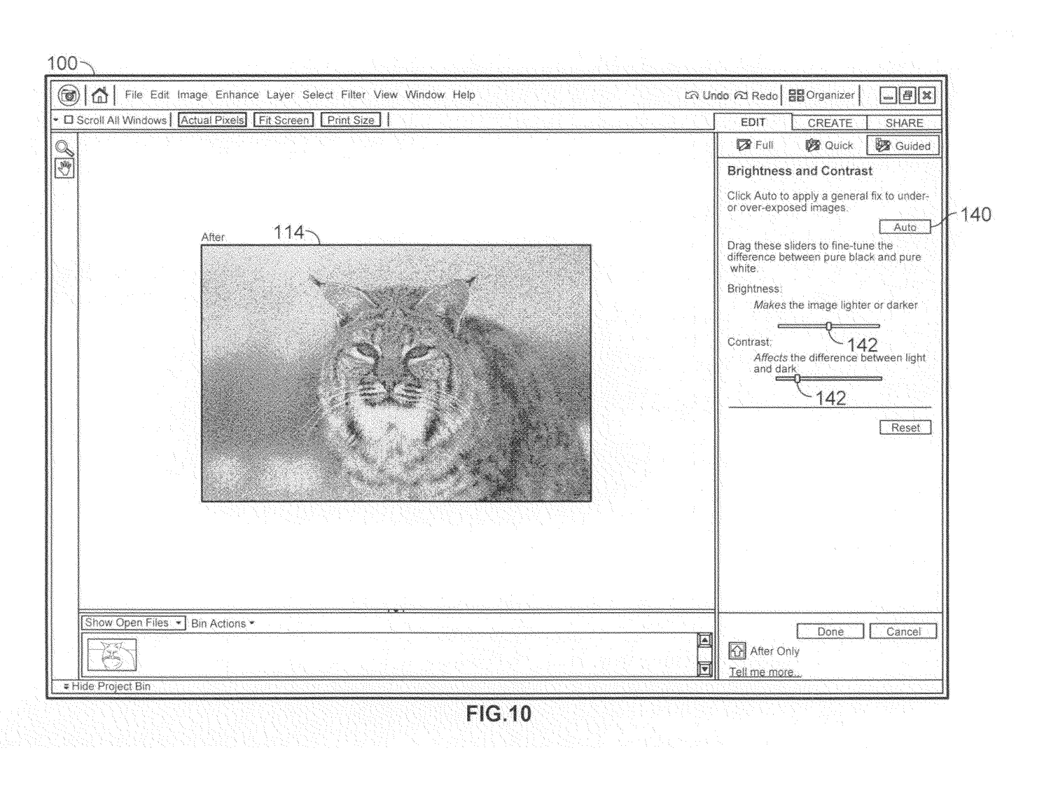

FIG. 10 is a diagram illustrating an embodiment of a brightness and contrast guided edit. In the example shown, a user can press auto button 140 to automatically apply a general fix for under or over overexposed images. To manually fine-tune the difference between pure black and pure white, sliders 142 can be used. One of sliders 142 affects the brightness (i.e., makes an image lighter or darker) and the other slider affect the contrast (i.e., affects the difference between light and dark).

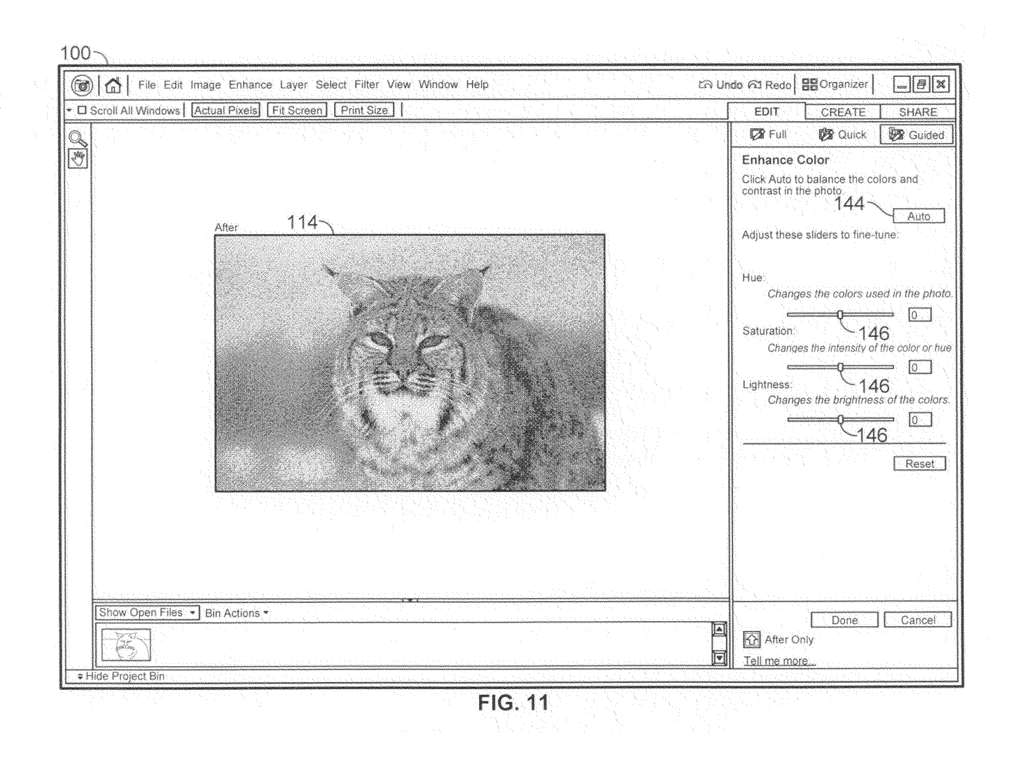

FIG. 11 is diagram illustrating an embodiment of a guided edit associated with enhancing color. In the example shown, pushing auto button 144 causes the colors and contrast of image 114 to automatically be balanced. Sliders 146 can be used to manually fine tune the color of image 114. One of sliders 146 adjusts the hue, another affects the saturation, and a third affects lightness.

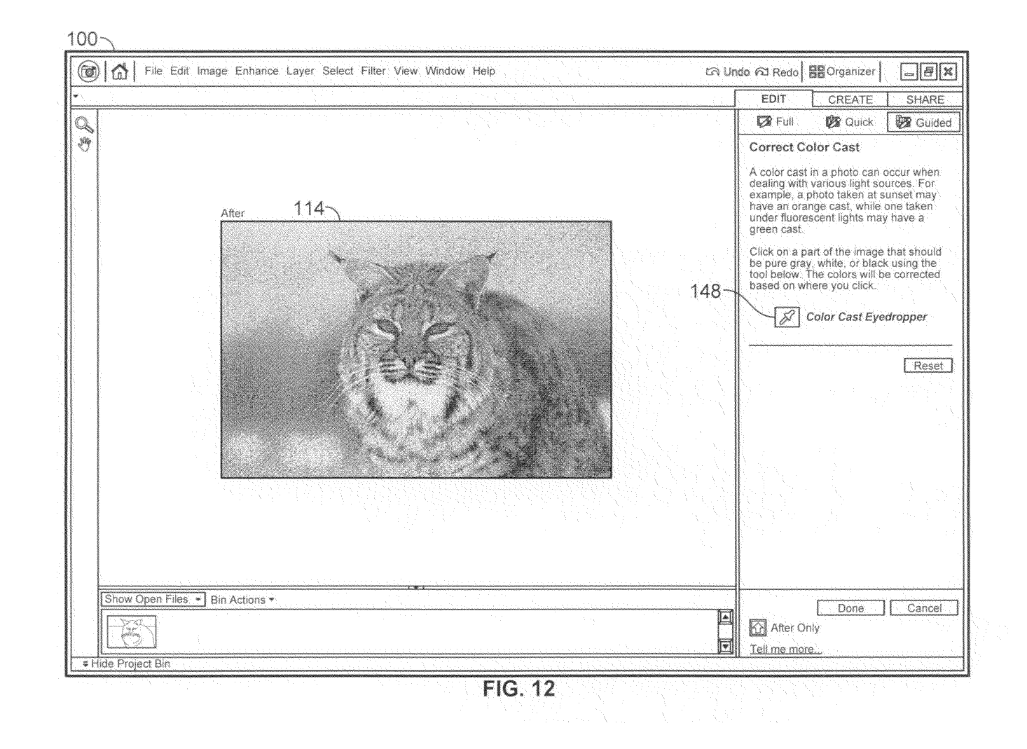

FIG. 12 is a diagram illustrating an embodiment of a guided edit associated with color cast. In the example shown, a user can adjust the color cast of an image or video. As recited in the text associated with the example guided edit, “For example, a photo taken at sunset may have an orange cast, while one taken under fluorescent lights may have a green cast.” In this embodiment, color cast eyedropper button 148 is displayed and selected. With this embodiment of a guided edit, a user only has to click on the part of the image that should be pure grey, white, or black.

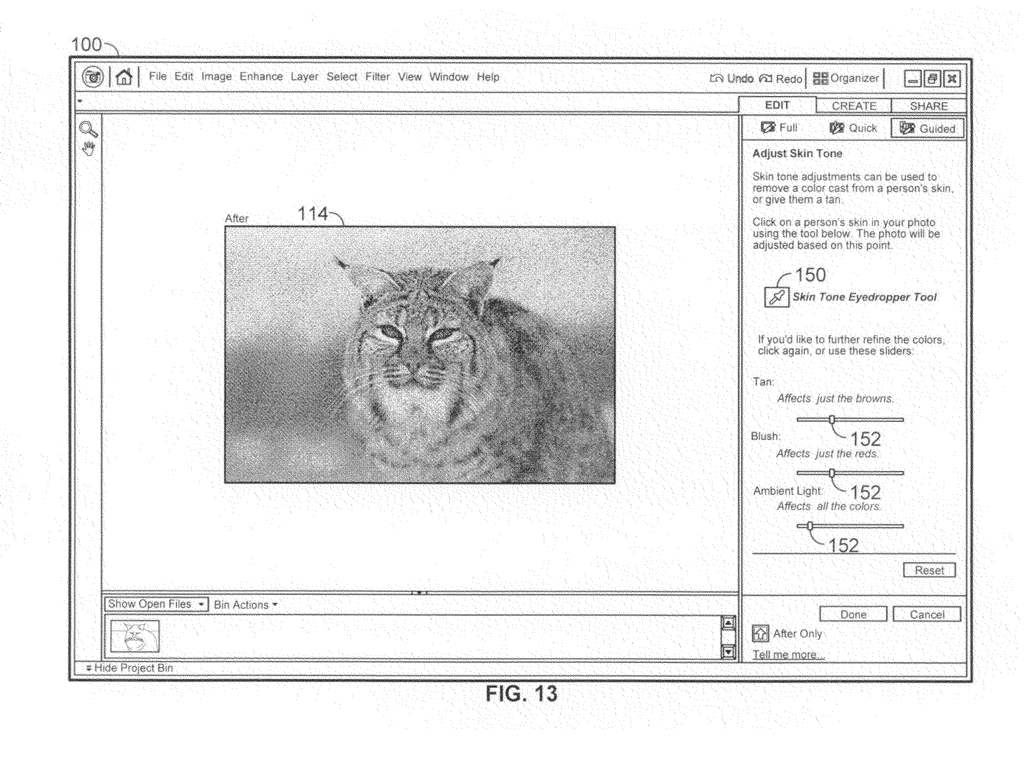

FIG. 13 is a diagram illustrating an embodiment of a skin tone correction guided edit. In the example shown, a user can use skin tone eyedropper tool button 150 and/or sliders 152 to remove a color cast from a person's skin or give them a tan. In this example, sliders 152 include a tan slider that affects just the browns, a blush slider that affects just the reds, and an ambient light slider that affects all of the colors.

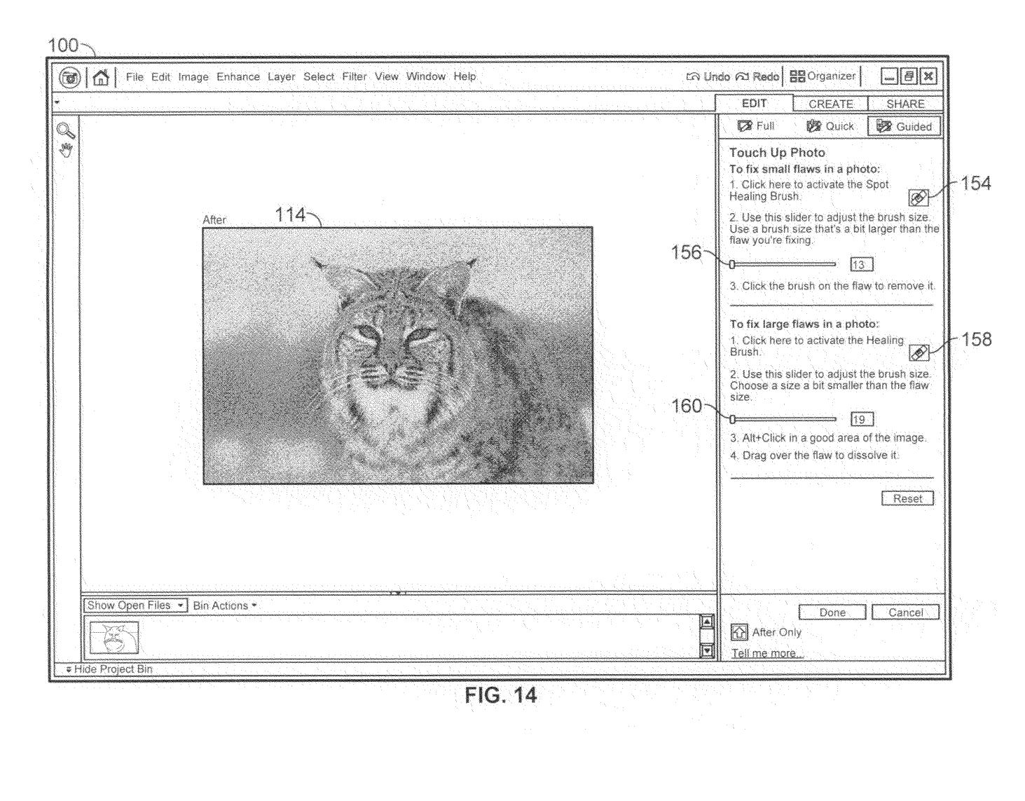

FIG. 14 is a diagram illustrating an embodiment of a guided edit for touching up an image. In the example shown, two sequences of steps or instructions for touching up an image are presented. The first sequence of steps is used to fix small flaws in a selected image (e.g., image 114) and includes the controls spot healing brush 154 and brush size slider 156 which increases/decreases the size of the spot healing brush. The second sequence of steps is used to fix larger flaws and includes healing brush 158 and brush size slider 160 that adjusts the size of the healing brush.

As shown in this example, some guided edits include steps that are performed in a certain order. This order may be a proper or recommended sequence of step. In some cases having a sequence of steps is useful because a user does not need to know or remember an order in which to perform a certain task or achieve a particular change. Another example of a sequence of steps included in a guided edit is to add color to a particular object by selecting a layer, creating a copy of the selected layer, moving the stacking of the newly created layer with respect to the layer being copied (if needed), changing the color of the newly created layer, etc.

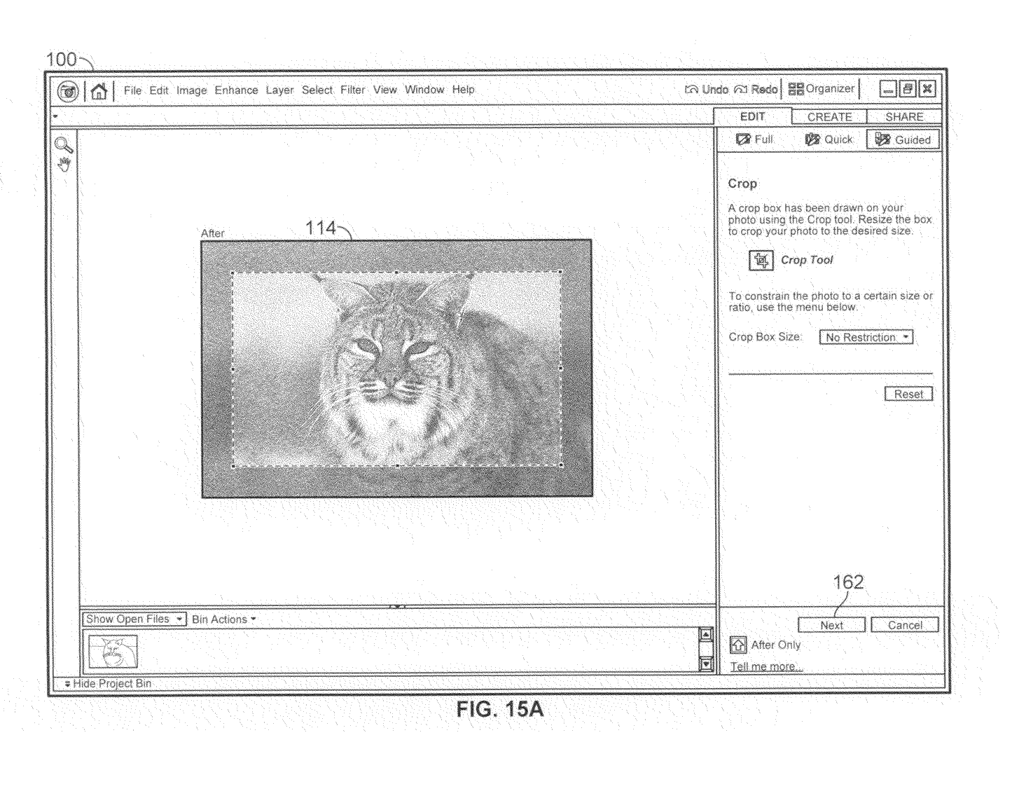

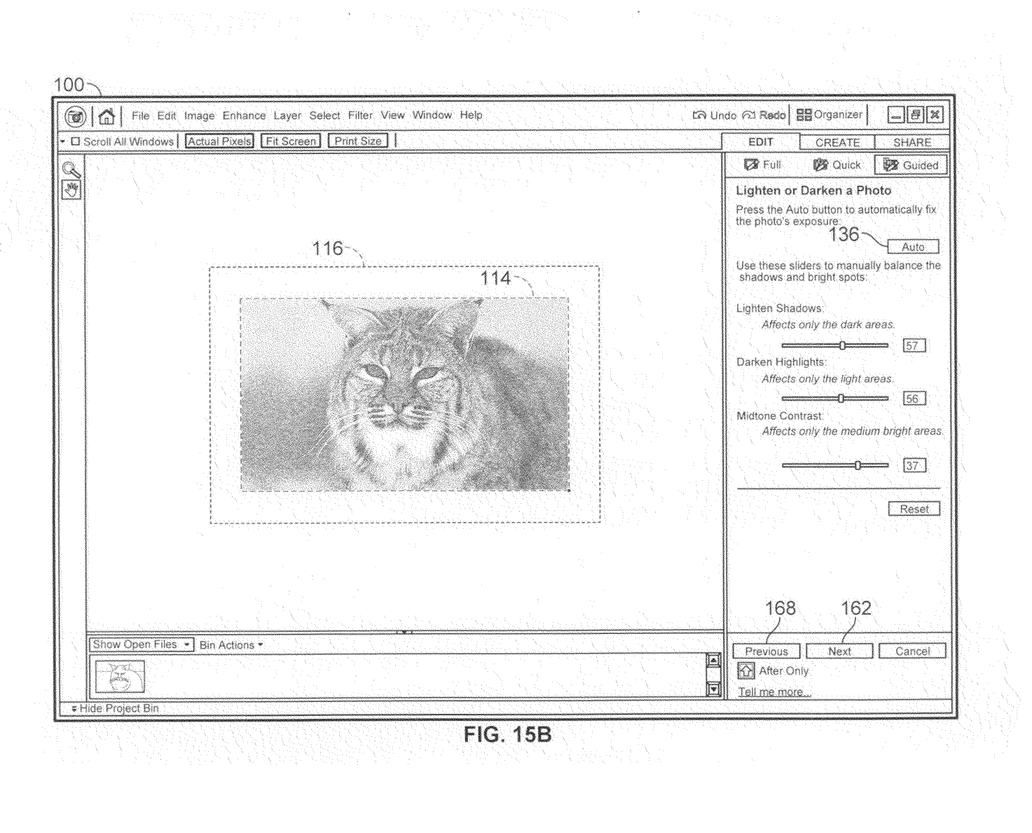

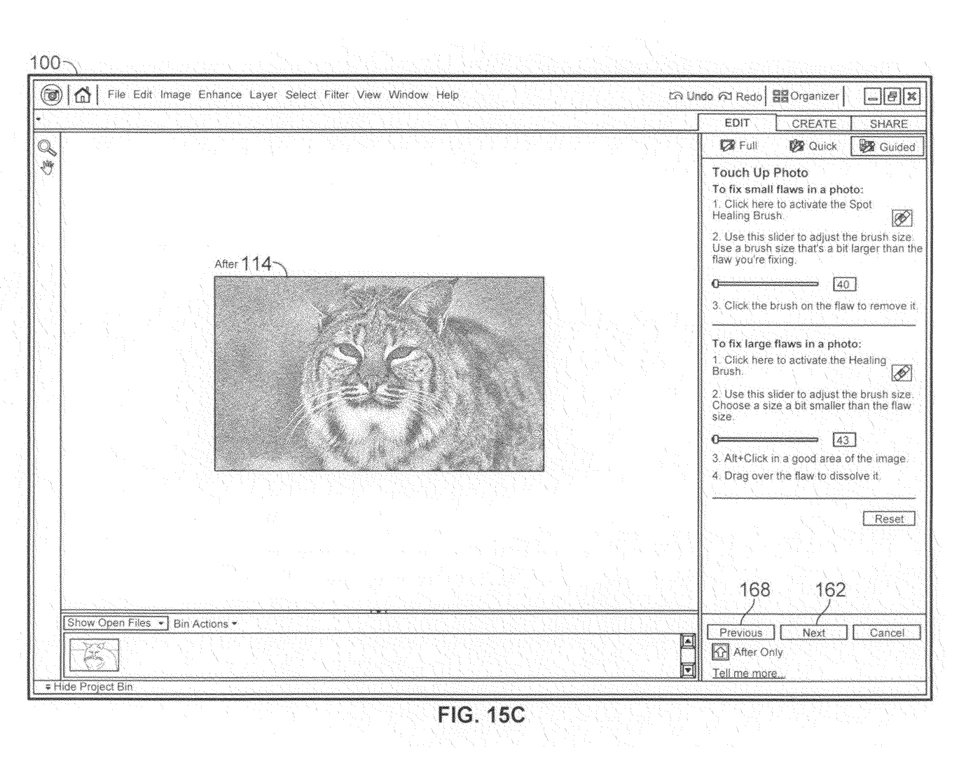

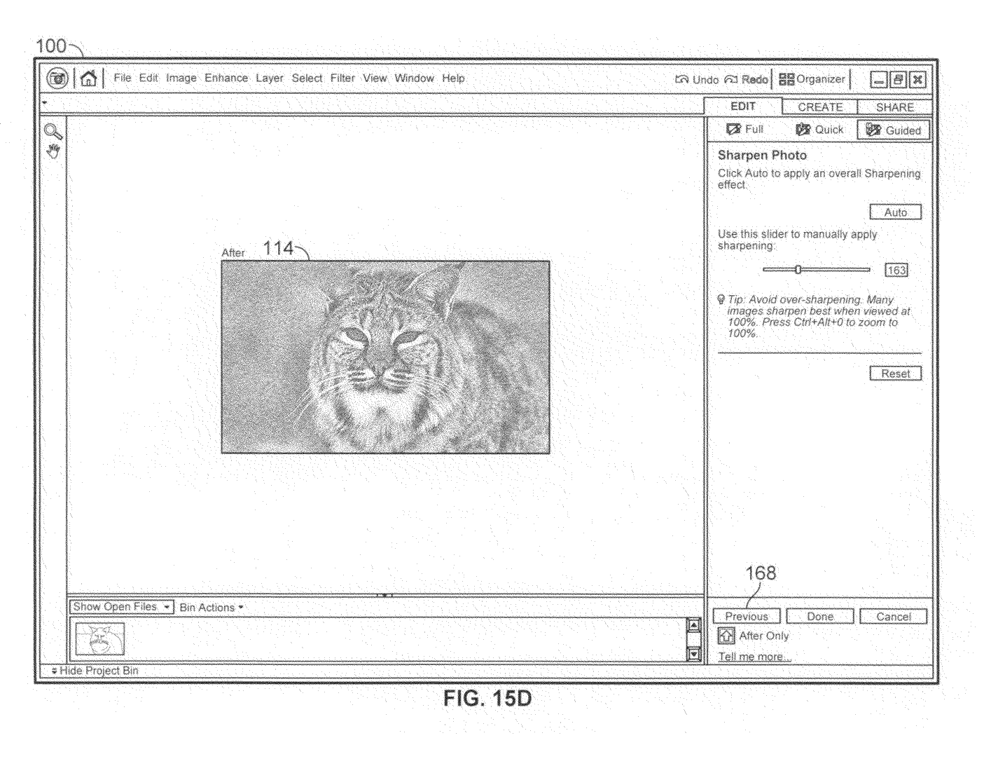

FIGS. 15A-15D are diagrams illustrating an embodiment of a guide for editing an image. In the example shown, the guide for editing an image is shown in guided edits list 106 in FIG. 1. In this example, the guide for editing an image is a combination or sequence of multiple guided edits. As the user progresses through each guided edit in the combination or sequence, the changes (if any) from the previous guided edits carry through. For clarity, a guided edit that comprises part of a combination or sequence of guided edits to an image is referred to as an atomic guided edit.

In some embodiments, a combination or sequence of guided edits is generated or combined by specifying the order of the atomic guided edits or the atomic guided edits that comprise a particular combination. In some such embodiments, one benefit is that the size of the guided edit file associated with the sequence or combination is smaller since it only contains references to the atomic guided edits. As shown in this example, in some embodiments each atomic guided edit can be treated separately and can be undone as a separate step. In some embodiments (e.g., this example) each step takes as its input the image that was manipulated by the previous step.

FIG. 15A shows an embodiment of a first atomic guided edit for cropping. The cropping atomic guided edit shown in this example is the same as that shown in FIG. 3, except FIG. 15A has next button 162 in place of done button 122. It is not necessary for a user to perform a particular atomic guided edit if she does not want to. For example, the user may not want to crop image 114 and may progress to the next atomic guided edit without cropping. Alternatively, if the user decides to crop image 114 the cropping is performed and the next atomic guided edit is performed on the cropped image.

FIG. 15B shows an embodiment of a second atomic guided edit associated with the lightening or darkening. In this particular example, the user has chosen to crop the image and box 164 shows the outline of image 114 prior to cropping. The lighten or darken atomic guided edit shown in FIG. 15B is similar to that shown in the example of FIG. 9 except for Previous and Next buttons 168 and 162. The ordering of the atomic guided edits may be selected based on a recommended or best-practices order. For example, the result from automatically fixing an image's exposure (e.g., by pressing auto button 136) may be better if the image is first cropped, rather than automatically fixing exposure and then cropping.

In this example, all atomic guided edits that are not the first atomic guided edit have a previous button (e.g., previous button 168). If desired, a user can go back to a previous or prior atomic guided edit (e.g., the cropping atomic guided edit shown in FIG. 15A).

FIG. 15C shows an embodiment of a third atomic guided edit associated with touching up. In the example shown, the touch up atomic guided edit is the similar to the guided edit shown in FIG. 14 except for Previous and Next buttons 168 and 162. Image 114 in this example has been cropped and lightened and/or darkened using the previous two atomic guided edits.

FIG. 15D is a diagram showing an embodiment of a fourth atomic guided edit for sharpening a photo. In this example, the atomic guided edit is the same as that shown in FIG. 8 except for the Previous button 168.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving a selection of visual data on which an edit is to be performed using an application;
obtaining information associated with the edit to be performed, the information including a description and a control;
obtaining parameter values used with a sequence of previous edits to the visual data;
simultaneously displaying, in a visual data display including a guided edit interface, the visual data, the description, the control, and at least one of the parameter values;
receiving, via the control, an indication to perform the edit;
performing the edit on the visual data to produce edited visual data; and
displaying the edited visual data.

2. The method as recited in claim 1, wherein the visual data includes one or more of an image and a video.

3. The method as recited in claim 1, wherein the control includes one or more of: a slider, a radio button, a pull down, a button, a box associated with an alphanumeric value, and a control for automatically performing the edit.

4. (canceled)

5. The method as recited in claim 1 further comprising:
displaying a list of a plurality of potential edits; and
receiving a selection from the plurality of potential edits, wherein obtaining the information includes obtaining information associated with the selected potential edit.

6. The method as recited in claim 1, wherein obtaining the information includes accessing a file associated with the edit to be performed.

7. The method as recited in claim 1, wherein obtaining the information includes accessing a file associated with the edit to be performed, and wherein the file is created and distributed by a third party for providing guided edits.

8. The method as recited in claim 1, wherein obtaining the information includes accessing a file associated with the edit to be performed, and wherein the file is associated with Adobe Flash.

9. The method as recited in claim 1, wherein the edit to be performed includes an edit associated with metadata, wherein the metadata includes a tag associated with a video or an image.

10. The method as recited in claim 1, wherein the edit to be performed includes adding or deleting information.

11. The method as recited in claim 1, wherein:
the control is associated with one or more of: cropping, sharpening, rotating, lightening shadows, darkening highlights, brightness, contrast, hue, saturation and merging a plurality of pieces of visual data; and
the at least one of the parameter values indicates a level, setting, or mode associated with a previous change to one or more of: a cropping size, a cropping dimension, an aspect ratio, sharpness, rotation, contrast, hue, saturation, and brightness of at least a portion of the visual data.

12. The method as recited in claim 1 further comprising:
receiving an indication associated with canceling one or more of the previous edits made to the visual data while simultaneously displaying the visual data, the description, respective ones of the parameter values corresponding to the one or more of the previous edits and the control;
undoing the one or more of the previous edits; and
ceasing to display the description, the respective ones of the parameter values, and the control.

13. The method as recited in claim 1 further comprising:
receiving an indication associated with resetting one or more of the previous edits made to the visual data while simultaneously displaying the visual data, the description, respective ones of the parameter values corresponding to the one or more of the previous edits, and the control; and
undoing the one or more of the previous edits.

14. The method as recited in claim 1 further comprising:
receiving an indication associated with ending display of the description and the control; and
ending display of the description and the control.

15. The method as recited in claim 1, further comprising:
obtaining a plurality of parameter values used with a plurality of previous edits to the visual data; and
constructing a sequence of guided edits using a plurality of atomic guided edits and the plurality of parameter values.

16. A system, comprising:
a processor; and
a memory having instructions stored thereon, which when executed by the processor, cause the processor to:
receive a selection of visual data on which an edit is to be performed;
obtain information associated with the edit to be performed, including a description and a control;
obtain parameter values used with a sequence of previous edits to the visual data;
simultaneously display, in a visual data display including a guided edit interface, the visual data, the description, the control, and at least one of the parameter values;
receive, via the control, an indication to perform the edit;
perform the edit on the visual data to produce edited visual data; and
display the edited visual data.

17. The system as recited in claim 16, wherein the control includes at least one of: a slider, a radio button, a pull down, a button, a box associated with an alphanumeric value or a control for automatically performing the edit.

18. (canceled)

19. The system as recited in claim 16, wherein the instructions further comprise instructions for:
displaying a list of a plurality of potential edits; and
receiving a selection from the plurality of potential edits, wherein obtaining the information includes obtaining information associated with the selected potential edit.

20. The system as recited in claim 16, wherein the control is associated with at least one of: cropping, sharpening, rotating, lightening shadows, darkening highlights, contrast, brightness, contrast, hue, saturation, lightness, or merging a plurality of pieces of visual data.

21. A non-transitory computer readable storage medium having computer instructions stored thereon, which, when executed by a processor, cause the processor to perform operations comprising:
receiving a selection of visual data on which an edit is to be performed;
obtaining information associated with the edit to be performed, including a description and a control;
obtaining parameter values used with a sequence of previous edits to the visual data;
simultaneously displaying, in a visual data display including a guided edit interface, the visual data, the description, the control, and at least one of the parameter values;
receiving via the control an indication to perform the edit;
performing the edit on the visual data to produce edited visual data; and
displaying the edited visual data.

22. The computer program product as recited in claim 21, wherein the control includes at least one of: a slider, a radio button, a pull down, a button, a box associated with an alphanumeric value or a control for automatically performing the edit.

23. (canceled)

24. The computer program product as recited in claim 21, the operations further comprising:
displaying a list of a plurality of potential edits; and
receiving a selection from the plurality of potential edits, wherein obtaining the information includes obtaining information associated with the selected potential edit.

25. The computer program product as recited in claim 21, wherein the control is associated with one or more of:
cropping, sharpening, rotating, lightening shadows, darkening highlights, brightness, contrast, hue, saturation and merging a plurality of pieces of visual data; and
the at least one of the parameter values indicates a level, setting, or mode associated with a previous change to one or more of: a cropping size, a cropping dimension, an aspect ratio, sharpness, rotation, contrast, hue, saturation, and brightness of at least a portion of the visual data.

26. The method as recited in claim 1, wherein:
the control includes a box which is configured to receive alphanumeric input; and
the simultaneously displaying includes displaying the box with at least one of the obtained parameter values filled in.

27. The system as recited in claim 16, wherein:
the control includes a box which is configured to receive alphanumeric input; and
the simultaneously displaying includes displaying the box with at least one of the obtained parameter values filled in.

28. The computer program product as recited in claim 21, wherein:
the control includes a box which is configured to receive alphanumeric input; and
the simultaneously displaying includes displaying the box with at least one of the obtained parameter values filled in.

29. The method as recited in claim 1, wherein:
the control includes a slider; and
the simultaneously displaying includes displaying the slider with the position of the slider set based at least in part on the at least one of the obtained parameter values.

30. The system as recited in claim 16, wherein:
the control includes a slider; and
the simultaneously displaying includes displaying the slider with the position of the slider set based at least in part on at least one of the obtained parameter values.

31. The computer program product as recited in claim 21, wherein:
the control includes a slider; and
the simultaneously displaying includes displaying the slider with the position of the slider set based at least in part on at least one of the obtained parameter values.
